(19) United States
(12) Patent Application Publication
(10) Pub. No.: US 2003/0117675 A1
(43) Pub. Date: Jun. 26, 2003

(54) Curved image conversion method and record medium where this method for converting curved image is recorded

(76) Inventors: Norimitu Shirato, Tokyo (JP); Hideyuki Matsumoto, Tokyo (JP); Tomoyoshi Ohtsuki, Kanagawa (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/169,741

(22) PCT Filed: Aug. 29, 2001
(86) PCT No.: PCT/JP01/07428

(30) Foreign Application Priority Data
Aug. 30, 2000 (JP) 2000-260619
Oct. 31, 2000 (JP) 2000-333670
Aug. 9, 2001 (JP) 2001-243019

(51) Int. Cl. H04N 1/04; H04N 1/46

(52) U.S. Cl. 358/505; 358/483

(57) ABSTRACT

A curved image conversion method is provided which converts a curved image formed by a fish-eye lens into a plane image at high speed. The conversion from the curved image into the plane image involves calculating through a geometry calculation projection points on a plane that are projected from sampling points on the curved image formed by the fish-eye lens.

### BACKGROUND OF THE INVENTION

1. Field of the Invention

The present invention relates to a curved image conversion method and a recording medium storing the same used, for example, in a surveillance system and more particularly to a method of converting a curved image of an object imaged by a reflecting mirror, such as a convex mirror, and a projection lens, such as a fish-eye lens, into a plane image as well as a recording medium storing the image conversion method.

2. Prior Art

Significant advances have been made in the computer-related technologies in recent years. Particularly, technologies associated with computer graphics have progressed remarkably as the processing speed of the computer itself and the storage capacities are increasing. The use of graphics processing software allows figures or images taken into the computer to be not only enlarged or reduced but also deformed arbitrarily. Deforming or morphing a image taken into the computer currently involves breaking down the image into pixels and performing complicated computations on each of the pixels to produce a desired deformed image.

However, since the image deformation processing described above requires performing complex calculations for each pixel, its practical application has been limited to drawing. If the image deformation processing can be done quickly, an image shot by a fish-eye lens, which can cover a wider viewing area than ordinary lenses, can be converted into a plane image for display. It is thus considered possible to build a surveillance system that can monitor a wide observation area with a smaller number of imaging operations.

When such image deformation processing is to be applied to a surveillance system or the like, however, the conventional processing technology, which must perform complex calculations on each pixel, inevitably increases the processing volume and therefore the amount of time required to a prohibitively high level. Particularly when an image to be processed has a high resolution or is a moving image, a great deal of processing cannot be finished in time, making it difficult to put the conventional technology to practical use. That is why it has found only a limited use in everyday life.

To deal with the problems described above, the actual amount of calculations may be reduced by preparing reference maps (visual point maps) for all pixels in advance and looking up the reference maps during the conversion process. Even with this technique, an interactive moving of the visual point is not realistic for a high quality image. This is explained as follows. Since this technique requires as a precondition that the visual point map be calculated for each pixel beforehand as described above, a huge amount of visual point maps must be prepared. Hence, it is not realistic to adopt this technique.

A technique for reducing the volume of calculations to be processed during an image conversion operation is disclosed in Japanese Patent Nos. 3051173 and 3012142. This technique transforms a curved image (a circular wide-angle image) from a polar coordinate system to an orthogonal coordinate system in advance and uses the orthogonal coordinate system when performing calculations for image mapping. With this technique, it is possible to reduce the actual volume of calculations and improve the processing speed, thus allowing the visual point in a high quality image to be moved interactively. It is therefore considered possible to convert even a moving image if the conditions are met.

In the inventions described in the above-cited official gazettes, however, the conversion processing is realized using an image that has been converted into the orthogonal coordinate system in advance. For example, to map a moving image in real time as it is taken in from a camera requires converting in real time all frames of the curved moving image into an orthogonal coordinate system. The real-time conversion of all frames of the curved moving image into the orthogonal coordinate system spoils the advantages of the inventions of the cited official gazettes and is not realistic in terms of the processing speed. Therefore, the above technique is not suited for the real-time conversion of an image as it is taken in, and a further development is being called for.

Under these circumstances the present invention has been accomplished to provide a curved image conversion method, capable of converting a curved image into a plane image quickly and applicable to a wide range of activities in everyday life, and also a recording medium storing the curved image conversion method. More specifically, the curved image conversion method, without having to perform preprocessing in advance, can directly use a curved image and perform fast conversion not only on a static image but also on a high quality moving image thus allowing for even a real-time, interactive mapping of moving images.

### SUMMARY OF THE INVENTION

Of the curved image conversion method and the recording medium storing the method according to the present invention, the curved image conversion method as claimed in claim 1 is a method for converting a curved image produced by an imaging means into a plane image, the method comprising the step of: calculating by a geometry calculation projection points on a plane that are projected from sampling points on the curved image formed by the imaging means to convert the curved image into the plane image without using an orthogonal system conversion algorithm.

Another aspect of the invention provides, as claimed in claim 2, a curved image conversion method for converting a curved image produced by an imaging means into a plane image, the method comprising the step of: calculating sampling points on the curved image based on projection characteristics of the imaging means to convert the curved image into the plane image without using an orthogonal system conversion algorithm.

More specifically, as claimed in claim 3, the curved image formed by the imaging means is converted into a plane image by building a spherical or planar polygon model based on the projection characteristics of the imaging means, matching the sampling points on the curved image to vertices of a plurality of polygons (e.g., triangles) making up the polygon model, converting them into a camera viewing field through a geometry conversion, performing various projection conversions and rasterizing the converted image.

The projection characteristics of the imaging means may, as claimed in claim 4, include parameters associated with a radius of curvature of the imaging means. Further, it is also possible to convert an arbitrary range of the curved image into a plane image, as claimed in claim 5, or convert a plurality of arbitrary ranges of the curved image simultaneously into a plane image, as claimed in claim 6, or even scale up or down an arbitrary range of the curved image and convert it into a plane image.

The imaging means may be a reflection mirror or a projection lens, as claimed in claim 8. More specifically, the reflection mirror may use a convex or concave mirror, as claimed in claim 9, and the projection lens may use a fish-eye lens, as claimed in claim 10.

Next, of the curved image conversion method and the recording medium storing the method, the recording medium as claimed in claim 11 is a recording medium storing a curved image conversion method, which method converts a curved image produced by an imaging means into a plane image, the method comprising the step of: calculating by a geometry calculation projection points on a plane that are projected from sampling points on the curved image formed by the imaging means to convert the curved image into the plane image without using an orthogonal system conversion algorithm.

A further aspect of the invention provides, as claimed in claim 12, a recording medium storing a curved image conversion method, which method converts a curved image produced by an imaging means into a plane image, the method comprising the step of: calculating sampling points on the curved image based on projection characteristics of the imaging means to convert the curved image into the plane image without using an orthogonal system conversion algorithm.

A further aspect of the invention provides, as claimed in claim 13, a recording medium storing a curved image conversion method, wherein the method converts the curved image formed by the imaging means into a plane image by building a spherical or planar polygon model based on the projection characteristics of the imaging means, matching the sampling points on the curved image to vertices of a plurality of polygons (e.g., triangles) making up the polygon model, converting them into a camera viewing field through a geometry conversion, performing various projection conversions and then rasterizing the converted image.

Further, the curved image conversion method stored in the recording medium may, as claimed in claim 14, convert an arbitrary range of the curved image into a plane image or, as claimed in claim 15, convert a plurality of arbitrary ranges of the curved image simultaneously into a plane image or, as claimed in claim 16, scale up or down an arbitrary range of the curved image and convert it into a plane image.

Since the curved image conversion method and the recording medium storing the same are configured as described above, they do not require any preprocessing, for example an orthogonal system conversion algorithm, as do the inventions disclosed in the above-cited official gazettes, and thus can directly use the curved image. This allows a real time mapping of a moving image. The use of a so-called texture mapping technique in the mapping process can reduce the overall volume of computations and thereby increase the processing speed.

### BRIEF DESCRIPTION OF THE DRAWINGS

FIG. 1 is a block diagram showing one embodiment of the present invention.

FIG. 2A illustrates a curved image produced by a fish-eye lens and FIG. 2B a plane image converted from the curved image by a conversion program.

FIG. 3 is a schematic diagram illustrating an algorithm of the present invention.

FIG. 4 is an explanatory diagram showing how a corresponding point in polar coordinates is determined.

FIG. 5 is an explanatory diagram showing a spherical polygon model built on the basis of projection characteristics.

FIG. 6 is a schematic diagram showing how a spherical plane is mapped.

FIG. 7 is a diagram showing how a projection point is determined.

FIG. 8 is an explanatory diagram showing a plane image converted from a curved image of the polygon model.

FIG. 9A illustrates a curved image produced by a fish-eye lens and FIG. 9B a plane image converted from the curved image by a conversion program.

FIG. 10 is a flow chart showing a sequence of steps in the image conversion operation in this embodiment.

### DETAILED DESCRIPTION OF PREFERRED EMBODIMENTS

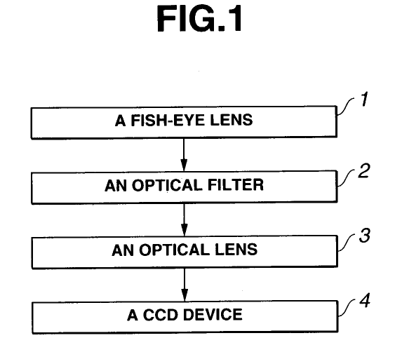

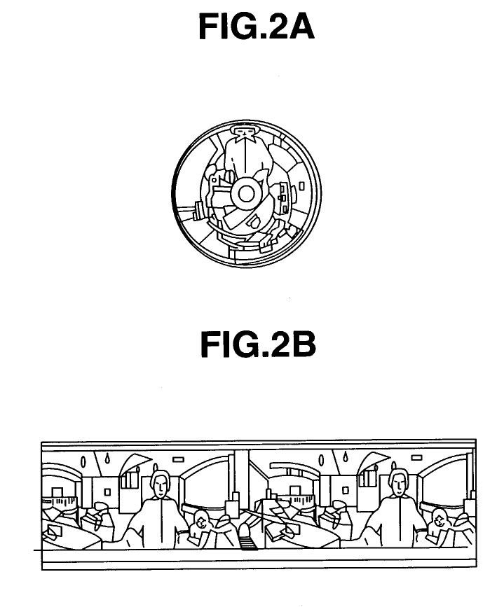

FIG. 1 and FIG. 2 show a first embodiment of the present invention as applied to a surveillance system. This surveillance system includes a fish-eye lens 1 or imaging means that forms an image, an optical filter 2, an optical lens 3, and a CCD device 4 constructed of a CCD camera. An image (curved image) produced by the fish-eye lens 1 is taken into the CCD device 4 through the optical filter 2 and the optical lens 3. The CCD device 4 is connected to a computer not shown and thus the curved image taken into the CCD device 4 is sent to this computer. The curved image refers to an image produced by the fish-eye lens 1. It is noted, however, that where a convex mirror, concave mirror or wide-angle lens is used in place of the fish-eye lens 1 as described later, the curved image refers to an image produced by the convex mirror, concave mirror or wide-angle lens.

The computer is installed with a conversion program that converts the curved image taken into the CCD device 4 into a plane image. The plane image refers to an image that is presented to user's eye. The computer is connected with a display unit not shown which displays the plane image that was generated by the conversion program.

The conversion program is a feature of this invention and converts the curved image formed by the imaging means into a plane image. In this embodiment, a geometric operation is performed to determine points on a plane projected from the corresponding sampling points on the curved image of an object produced by the fish-eye lens 1 and thereby transform the curved image into a plane image. That is, the process of converting a curved image formed by the imaging means into a plane image involves calculating sampling points on the curved image based on projection characteristics of the fish-eye lens 1, building a spherical polygon model (globular polygon), matching the sampling points one-to-one to vertices of a plurality of triangles that make up the polygon model, converting them into the corresponding points in a camera viewing field by using the geometric operation and then performing various projection conversions. While the polygon model refers to a model made up of a number of polygons, this and the second embodiments deal with models constructed of triangular polygons.

In other words, a virtual camera having a line of sight, a viewing angle, a clipping plane and a banking angle is assumed to exist in a three-dimensional space. Looking at the polygon model through the camera disposed at an origin of the polygon model results in a plane image converted from the curved image. In practice, this process consists in determining destination points on the two-dimensional image that are projected from the sampling points through the virtual camera and filling the triangular area of each sampling point without a gap by texture mapping. This process obviates the need for performing complicated calculations for each of a large number of pixels as required by the conventional method, and allows for a fast conversion.

The plane image generated by the method of this embodiment is an approximated image. However, the approximated image can be made close to an actual image as by increasing the number of polygons in the polygon model or changing the density of the polygon model.

While in the above embodiment, the imaging means uses a fish-eye lens 1 which is a projection lens, it may also use a wide-angle lens, which is the projection lens, and a convex mirror or concave mirror, which is a reflection mirror.

This embodiment with the above construction operates as follows. An image (curved image) as shown in FIG. 2A is formed by the fish-eye lens 1. This curved image is taken into the CCD device 4 and then converted into a plane image by the conversion program. As described above, this conversion is performed at high speed compared with that of the conventional method. The converted plane image is presented on the display unit. FIG. 2B illustrates the plane image shown on the display unit.

As is seen from FIG. 2, in this embodiment, it is possible with the single fish-eye lens 1 and the single CCD device 4 to display almost the whole interior of a room on the display unit. Hence, there is no need to install a large number of surveillance cameras.

Since the curved image conversion method of this invention can convert a curved image into a plane image at high speed, it is highly practical, being able to be applied to a variety of equipment including the above-described surveillance system.

Further, the curved image conversion method described above can be stored in a variety of recording mediums, such as flexible disks (FDs), magnetooptical disks (MOs) and CD-ROMs, for distribution.

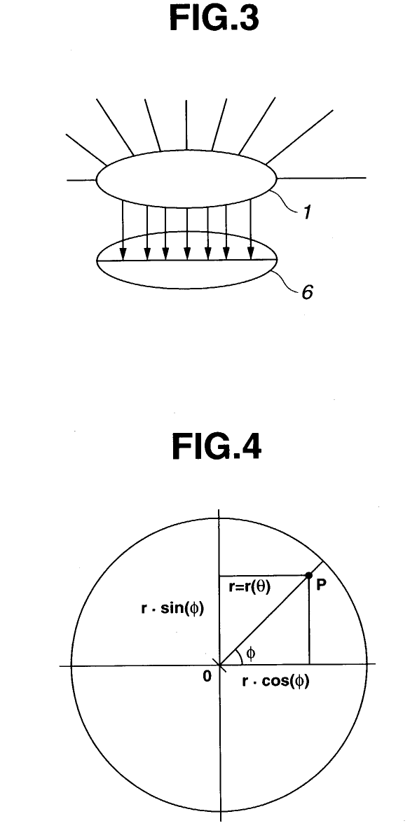

Next, FIG. 3 through FIG. 10 show a second embodiment of this invention as applied to a surveillance system. The surveillance system of this embodiment has, as in the first embodiment, a fish-eye lens 1 which is an imaging means, an optical filter 2, an optical lens 3, and a CCD device 4 constructed of a CD camera, as shown in FIG. 1. An image (curved image) formed by the fish-eye lens 1 is taken into the CCD device 4 through the optical filter 2 and the optical lens 3. The CCD device 4 is connected to a computer not shown, so the curved image taken into the CCD device 4 is sent to the computer. The curved image described above refers to an image produced by the fish-eye lens 1. If the fish-eye lens 1 is replaced with a convex mirror, a concave mirror or a wide-angle lens, the curved image refers to an image produced by the convex mirror, concave mirror or wide-angle lens.

The computer is installed with a conversion program that transforms a curved image taken into the CCD device 4 into a plane image. The computer is connected with a display unit not shown which displays the plane image converted by the conversion program.

Next, the conversion program will be explained. Before proceeding to the explanation of the conversion program, an algorithm of conversion processing according to this invention will be briefly described.

As shown in FIG. 3, a curved image 6 photographed by the fish-eye lens 1 is recorded by projecting a three-dimensional space around the fish-eye lens 1 onto a two-dimensional, circular image. Where in the two-dimensional circular image selected points in the three-dimensional space will be projected onto is determined by projection characteristics of the fish-eye lens 1 used. Depending on the projection characteristics of the lens, an information volume distribution density varies from the center of the circular image to its periphery and in general tends to be coarser at the outer side.

Mapping from the curved image 6 onto a plane image (conversion operation) is done by determining matching points between the plane coordinates and the polar coordinates. As shown in FIG. 4, polar coordinate parameters may be summarized as follows:

| | |
|---|---|
| p: | (r · cosφ, r · sinφ) |
| r: | R · f(θ) |
| f(θ): | {0 < f (θ) < 1} |
| θ: | {0 < θ < 1} |
| φ: | {0 < φ < 2π |

where R is a radius of the curved image, p is an arbitrary point, r is a distance from an origin to the point p, and θ and φ are parameters given from outside. f(θ) is a function representing projection characteristics of the fish-eye lens 1.

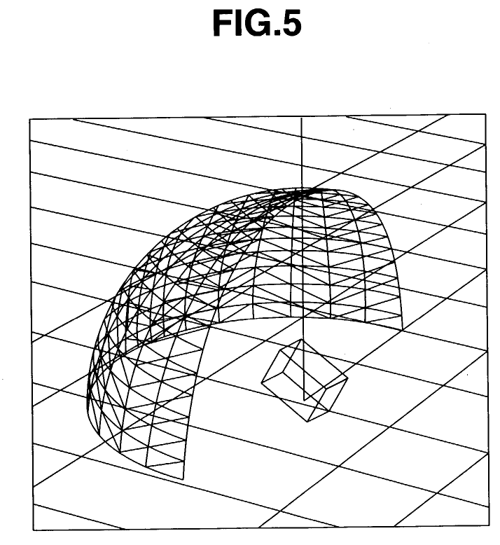

The algorithm according to this invention involves generating a spherical polygon model made up of a plurality of triangles, as shown in FIG. 5, accurately mapping vertices of triangles in the polygon model onto the corresponding sampling points on the curved image by taking the projection characteristics of the lens into account, and looking at the interior of the spherical polygon model from a virtual camera positioned at the center of the spherical model to produce a perspective image. Calculations on pixels inside each of the triangles are performed with approximation using a texture mapping technique. Therefore, while the conventional conversion operation that is performed for each pixel is complicated and huge in volume, the method of this invention reduces an overall volume of calculations, allowing for a higher speed of the conversion operation.

A processing system of recent years generally has come to support the texture mapping with hardware and thus can process a perspective correction output very fast. Therefore, the method of this invention does not require an orthogonal conversion algorithm, as does the conventional method, to convert the original image into an orthogonal coordinate system in advance. Further, determining an opening θ of the spherical polygon model according to the angle of view of a lens used can deal with any lens with an arbitrary angle of view, without requiring information on a focal length of the lens.

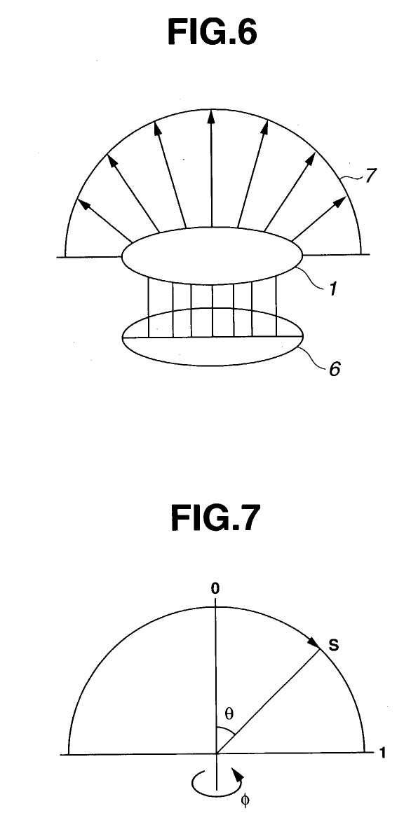

A spherical mapping is a mapping that seeks to reproduce the original three-dimensional space by tracing backward light paths, which were projected from a three-dimensional space onto a curved image. As shown in FIG. 6, a sphere 7 is assumed to be placed in a virtual three-dimensional space and intersections are contemplated which are formed between the sphere 7 and rays of light running from the curved image toward the space. And in this condition we will consider the process of texture-mapping the curved image onto the inside of the sphere 7.

At this time, putting a virtual camera at the center of the sphere 7 and viewing the inside of the sphere from the camera results in the original three-dimensional space being reproduced. Because the spherical mapping reproduces the original three-dimensional space inside the sphere 7 in the virtual space, the user can look in any desired direction or scale up or down the image by simply manipulating the virtual camera placed at the center of the sphere 7. Further, since any number of virtual cameras can be added, one original image can be viewed from various angles at the same time to output multiple perspective views. This allows a plurality of users to actively view the original image from desired angles simultaneously and output multiple perspective views.

The actual mapping procedure involves projecting vertices of the triangles that make up the spherical polygon model onto the original image, as in the light paths running from the three-dimensional space to the curved image. At this time, by taking the projection characteristics of the lens into account, it is possible to deal with a variety of lenses with differing projection characteristics.

To determine pixel points p on the curved image that are projected from the polygon vertices on the sphere 7 requires giving the parameters θ and φ. As shown in FIG. 7, if an apex of the sphere is taken to be the beginning of θ, the polygon vertex coordinates s in the three-dimensional space are determined as follows:

s: (θ, φ)

Substituting the vertex parameters θ and φ in the polar coordinates of FIG. 4 results in the destination projection points p on the polar coordinates being determined with respect to the apex of the sphere 7. The curved image that was texture-mapped onto the spherical polygon model is subjected to a rendering operation through the virtual camera and then mapped onto a two-dimensional perspective correction image. It is needless to say that taking these parameters θ and φ as an abscissa and an ordinate of planar polygons, respectively, results in a panoramic mapping that utilizes the planar polygons. That is, although the present invention does not use an orthogonal system conversion algorithm in producing a perspective correction image, it can generate a panoramically mapped image simultaneously with the perspective correction image.

The rendering operation performed through the virtual camera uses a 3D geometry calculation. Although the representation of the 3D geometry calculation varies depending on the processing system used, the 3D geometry calculation will be explained by using, for example, a left-handed coordinate system and line (lateral) vector representation. Generally, the 3D geometry calculation is done in a variety of matrix operations using homogeneous four-dimensional coordinates. With vertices on the polygon model taken as [xyz1] and converted vertices as [x′y′z′1], the 3D geometry calculation can generally be expressed as follows.

[x′y′z′1]=[xyz1]*[W*[V]*[P]

where [W] is a world conversion matrix, [V] is a view conversion matrix, and [P] is a projection conversion matrix. The world conversion matrix is a conversion matrix from an object coordinate system into a world coordinate system; the view conversion matrix is a conversion matrix from a world coordinate system into a camera coordinate system; and the projection conversion matrix is a conversion matrix from a camera coordinate system into a projection space (perspective, corrected homogeneous space).

The polygon vertices that were converted into the projection space are generally subjected to the clipping operation and the view port conversion operation and then mapped onto a two-dimensional plane. After this, the polygon vertices are subjected to a rendering process using the texture mapping in such a manner as to complement areas between the polygon vertices and thereby generate an image. The portions [V] and [P] provide virtual camera functions. By setting a desired direction of the sight line with [V], the pan, tilt and rotation of the camera can be realized. [P] performs the perspective correction to realize the zoom-in/out of the camera. The conversion among these coordinates is realized by combining four operations on the vertices, i.e., translating, rotation, scaling and shear.

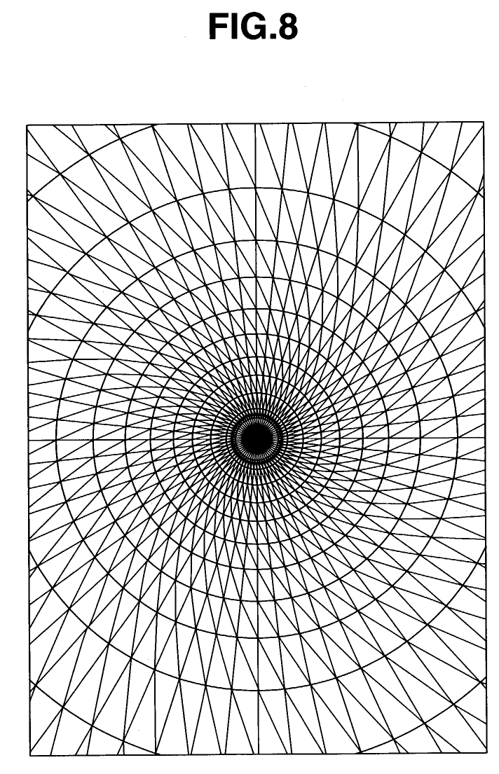

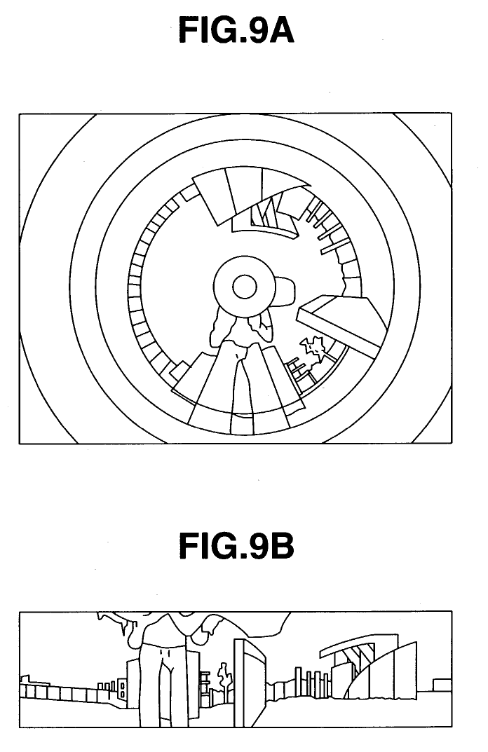

The conversion program based on the algorithm described above constitutes a feature of this invention and is designed to convert the curved image formed by the imaging means into a plane image. As shown in FIG. 8 and FIG. 9, this conversion program calculates sampling points on the curved image based on the projection characteristics of the fish-eye lens 1 and transforms the curved image into a plane image. That is, the conversion process involves calculating the sampling points on the curved image based on the projection characteristics including those associated with a radius of curvature of the fish-eye lens 1, building a spherical polygon model according to the projection characteristics, matching the sampling points on the curved image to the vertices of a plurality of triangles making up the polygon model, converting them into a camera viewing field system by the geometry conversion, performing a variety of projection conversions, and then rasterizing the image to transform the curved image into a plane image. The projection characteristics are determined manually or automatically as in the first embodiment or by using various engineering and mathematical techniques.

Based on the projection characteristics of the fish-eye lens 1, the vertices of a plurality of triangles on the polygon model are transformed by the geometry conversion into a camera coordinate system where they are subjected to various projection processing such as parallel projection and perspective projection, thus determining destination pixels on the plane that are projected from the vertices. Next, triangular sampling areas on the curved image that correspond to the triangular areas on the plane determined as described above are deformed as required and rasterized. That is, for each pixel in the triangular areas on the plane, a pixel on the curved image that should be referenced is determined. These processing are not calculations in a strict sense of the word but approximations, which can improve the processing speed.

In other words, if a virtual camera with a line of sight, a viewing angle, a clipping plane and a banking angle is assumed to be placed in a three-dimensional space and one looks through the camera positioned at an origin of the polygon model, then he or she can see a plane image that was converted from the curved image. In practice, this conversion procedure consists in determining destination points on the two-dimensional image that are projected from the sampling points through the virtual camera and filling the triangular area of each sampling point without a gap by texture mapping. This process obviates the need for performing complex calculations for each of a large number of pixels as required by the conventional method, and enables a fast conversion.

The plane image produced by the method of this embodiment is an approximated image but, as in the first embodiment described above, it can be made close to an actual image as by increasing the number of polygons in the polygon model or improving the density of the polygon model, as required.

Although the above embodiment employs as the imaging means the fish-eye lens 1 which is a projection lens, it is also possible to use a convex or concave mirror,.which is a reflection mirror, and a wide-angle lens, which is a projection lens.

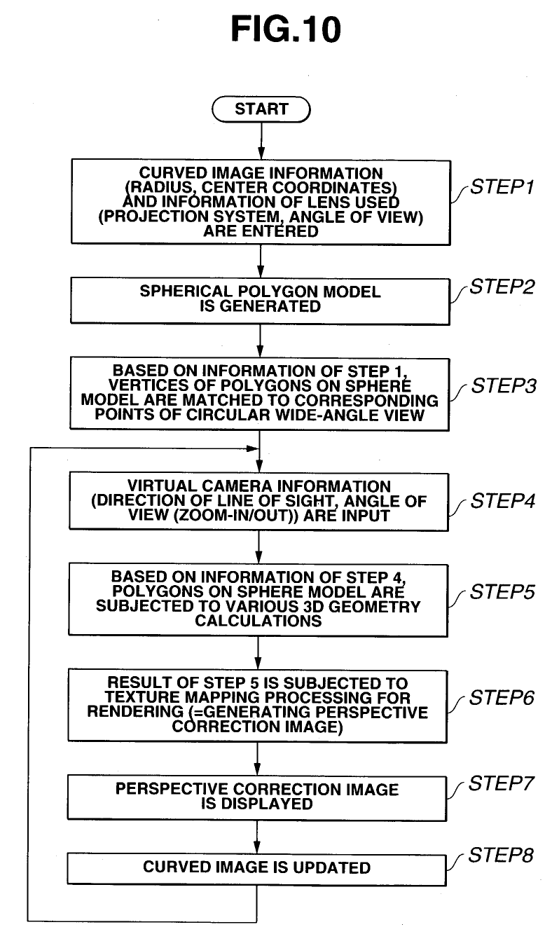

This embodiment constructed as described above operates as follows. As shown in FIG. 10, the conversion program first takes in curved image information (radius and center coordinates) and information on the lens used (projection system and angle of view) (step 1). Next, at step 2, a spherical polygon model is generated. Then, at step 3, based on the information taken in at step 1, vertices of polygons on the spherical model are matched to the corresponding points on the curved image. Since the polygons on the spherical model are triangles, this step has the same meaning as matching the curved image to the triangle areas. Further at step 4, the program inputs information on the virtual camera (line of sight and angle of view (zoom-in/zoom-out)). Then, the program proceeds to step 5 where, based on the information taken in at step 4, polygons on the sphere are subjected to various 3D geometry calculations. The 3D geometry calculations include a world conversion, a view conversion, a projection conversion, clipping processing and a view port conversion. Further, at step 6, the result of step 5 is subjected to texture mapping processing for rendering. This generates a perspective correction image. The texture mapping is performed on each triangle. This simplifies the processing and increases the image conversion speed. Next, the program moves to step 7 where it displays the perspective correction image thus obtained. At a final step 8, the program updates the curved image before it returns to step 4. The processing from step 4 to step 8 is repeated a required number of times.

As described above, the image (curved image) formed by the fish-eye lens 1, such as shown in FIG. 9A, is taken into the CCD device 4 and the image taken in is converted into a plane image by the conversion program. The burden on the computer can be alleviated by performing the curved image-to-plane image conversion through a predetermined angle (for example, 90 degrees) at a time. As described earlier, this conversion is processed at higher speed than in the conventional method. The converted plane image is displayed on the display unit. FIG. 9B shows a plane image displayed on the display unit.

As can be seen from FIG. 9, this embodiment can display on the display unit almost the entire area in the room with the single fish-eye lens 1 and the single CCD device 4. Hence, there is no need to install a large number of surveillance cameras as in the conventional surveillance system.

Because the curve image conversion method of this invention can convert a curved image into a plane image at high speed, it is very practical, capable of being applied not only to the aforementioned surveillance system but to various other equipment.

Further, the curved image conversion method described above can be recorded in a variety of recording mediums, such as flexible disks (FD), magnetooptical disks (MO) and CD-ROMs for distribution.

The perspective correction output requires huge volumes of calculations to be performed. Hence, the inventions disclosed in the official gazettes cited earlier improve the structure of data to be used in order to simplify the subsequent computations to make the perspective correction practical. That is, the original image is converted in advance into a target data structure. As a result, in the inventions disclosed in the official gazettes, a large amount of time is taken by the data structure conversion, so that when an image to be converted is a moving image, the real time performance or capability (conversion processing performed in real time as the moving image is taken in) is lost. The feasibility of the real time performance becomes more difficult as the image quality increases. Therefore, the inventions of the official gazette can be effectively used for images photographed in advance (still images and moving images). In other words, interactive, high-quality moving images requiring a real time capability are not realistic for the inventions of the official gazettes.

To describe in more detail, the inventions of the cited official gazettes use the orthogonal system conversion algorithm and data structure to simplify the subsequent calculations and thereby realize an interactive moving of a visual point relative to a high-quality image. The use of the orthogonal system conversion algorithm, however, makes it necessary to convert the curved image into an orthogonal coordinate system in advance. Performing a desired data structure conversion for each frame of the moving image entails very high cost, making it difficult to realize an interactive, high-quality moving image with a real time capability.

In the case of the data structure of the above embodiment, on the other hand, the curved image can be used as is and triangle texture polygons are handled as conversion units to improve calculation speed. As a result, it is only at the first time that the polygon model and the texture need to be matched. This in turn realizes an interactive, high-quality moving image with a real time capability which has been difficult to achieve with the inventions of the official gazettes. Further, by modifying the precision of the polygon model, the quality of the generated image and the burden on the processing system can be adjusted.

The effect produced by this invention will be described in more detail. In the inventions of the official gazettes cited earlier, an orthogonal system conversion algorithm (panoramic-mapped image) is used to realize a direct mapping of the hemispherical image area onto a corrected image. This conventional method performs a conversion from the polar coordinate system into the orthogonal coordinate system in advance to simplify the computations following the panoramic mapping and thereby quicken the perspective output conversion. However, because the panoramic mapping needs to be done in advance, this method is not suited for those applications where perspective images are output in real time as images are captured from the camera.

In the present invention, on the other hand, a perspective output is produced by directly matching the sampling points on a hemispherical image area to polygon vertices on a spherical polygon model in a virtual three-dimensional space and then looking up at the interior of the sphere through a virtual camera. Therefore, this invention does not require an orthogonal system conversion algorithm as do the inventions of the above-cited official gazettes. Hence, the present invention does not require preprocessing, such as panoramic mapping, to be performed in advance and can directly use the hemispherical image area. The method of this invention is suited not only for still images but also for outputting perspective views in real time while capturing images from a camera. Further, the method of this invention can deal with a variety of fish-eye lenses of different projection types and has a wide range of applications. Further, determining the opening of the sphere according to the angle of view of the lens used makes it possible to deal with any lens with an arbitrary angle of view without requiring information on a focal length of the lens.

Industrial Applicability

Configured and operated as described above, the present invention can convert a curved image into a plane image at high speed and therefore is highly practical, being able to be applied to a variety of equipment including a surveillance system.

What is claimed is:

1. A method for converting a curved image produced by an imaging means into a plane image, the method comprising the step of:
calculating by a geometry calculation projection points on a plane that are projected from sampling points on the curved image formed by the imaging means to convert the curved image into the plane image without using an orthogonal system conversion algorithm.

2. A method for converting a curved image produced by an imaging means into a plane image, the method comprising the step of:
calculating sampling points on the curved image based on projection characteristics of the imaging means to convert the curved image into the plane image without using an orthogonal system conversion algorithm.

3. A method according to claim 2 wherein the curved image formed by the imaging means is converted into a plane image by building a spherical or planar polygon model based on the projection characteristics of the imaging means, matching the sampling points on the curved image to vertices of a plurality of polygons making up the polygon model, converting them into a camera viewing field through a geometry conversion, performing various projection conversions and rasterizing the converted image.

4. A method according to claim 2 or 3, wherein the projection characteristics of the imaging means include parameters associated with a radius of curvature of the imaging means.

5. A method according to any one of claims 1 to 4, wherein an arbitrary range of the curved image is converted into a plane image.

6. A method according to any one of claims 1 to 4, wherein a plurality of arbitrary ranges of the curved image are converted simultaneously into a plane image.

7. A method according to any one of claims 1 to 6, wherein an arbitrary range of the curved image is scaled up or down and converted into a plane image.

8. A method according to any one of claims 1 to 7, wherein the imaging means is a projection lens or a reflection mirror.

9. A method according to claim 8, wherein the reflection mirror is a convex or concave mirror.

10. A method according to claim 8, wherein the projection lens is a fish-eye lens or a wide-angle lens.

11. A recording medium storing a curved image conversion method, which method converts a curved image produced by an imaging means into a plane image, the method comprising the step of:
calculating by a geometry calculation projection points on a plane that are projected from sampling points on the curved image formed by the imaging means to convert the curved image into the plane image without using an orthogonal system conversion algorithm.

12. A recording medium storing a curved image conversion method, which method converts a curved image produced by an imaging means into a plane image, the method comprising the step of:
calculating sampling points on the curved image based on projection characteristics of the imaging means to convert the curved image into the plane image without using an orthogonal system conversion algorithm.

13. A recording medium storing a curved image conversion method according to claim 12, wherein the method converts the curved image formed by the imaging means into a plane image by building a spherical or planar polygon model based on the projection characteristics of the imaging means, matching the sampling points on the curved image to vertices of a plurality of polygons making up the polygon model, converting them into a camera viewing field through a geometry conversion, performing various projection conversions and then rasterizing the converted image.

14. A recording medium storing a curved image conversion method according to any one of claims 11 to 13, wherein the method converts an arbitrary range of the curved image into a plane image.

15. A recording medium storing a curved image conversion method according to any one of claims 11 to 13, wherein the method converts a plurality of arbitrary ranges of the curved image simultaneously into a plane image.

16. A recording medium storing a curved image conversion method according to any one of claims 11 to 15, wherein the method scales up or down an arbitrary range of the curved image and converts it into a plane image.
